(19) United States
(12) Patent Application Publication
(10) Pub. No.: US 2025/0342488 A1
(43) Pub. Date: Nov. 6, 2025

(54) METHOD AND APPARATUS OF GENERATING ANTI-FORGERY INFORMATION, AND METHOD AND APPARATUS OF VERIFYING PRODUCT

(71) Applicant: BOE Technology Group Co., Ltd., Beijing (CN)

(72) Inventor: Wei PAN, Beijing (CN)

(21) Appl. No.: 18/994,320

(22) PCT Filed: Apr. 28, 2023
(86) PCT No.: PCT/CN2023/091668

§ 371 Date: Jan. 14, 2025

(51) Int. Cl. G06Q 30/018

(52) U.S. Cl. CPC G06Q 30/0185; G06Q 2220/00

(57) ABSTRACT

A method and apparatus of generating an anti-forgery information and a method and apparatus of verifying a product are provided. The method includes: performing a classification on a product information according to a field type of the product information, so as to obtain a numeric field and a text field; encoding the text field to obtain an encoded field; generating a field to be processed, according to a random number, the numeric field and the encoded field; encrypting the field to be processed to obtain an initial anti-forgery field; and generating a target anti-forgery information according to the initial anti-forgery field and the numeric field.

### TECHNICAL FIELD

The present disclosure relates to a field of anti-forgery technology, and more specifically, to a method and apparatus of generating an anti-forgery information and a method and apparatus of verifying a product.

### BACKGROUND

Anti-forgery technology is currently an effective means to protect legitimate interests of genuine manufacturers and consumers. With a development of computer technology, the anti-forgery technology is constantly updated to meet different requirements of products in different fields for a complexity of the anti-forgery technology.

### SUMMARY

In view of this, the present disclosure provides a method and apparatus of generating an anti-forgery information, a method and apparatus of verifying a product, an electronic device, and a medium.

In an aspect of the present disclosure, a method of generating an anti-forgery information is provided, including: performing a classification on a product information according to a field type of the product information, so as to obtain a numeric field and a text field; encoding the text field to obtain an encoded field; generating a field to be processed, according to a random number, the numeric field and the encoded field; encrypting the field to be processed to obtain an initial anti-forgery field; and generating a target anti-forgery information according to the initial anti-forgery field and the numeric field.

In another aspect of the present disclosure, a method of verifying a product is provided, including: acquiring, in response to a verification request for a product information being received, the product information and an anti-forgery information corresponding to the product information, wherein the anti-forgery information is generated using the above-mentioned method of generating the anti-forgery information; obtaining, by querying an anti-forgery information database, an embedding position information of a numeric field according to the product information; obtaining, from the anti-forgery information, the numeric field and an initial anti-forgery field according to the embedding position information of the numeric field; decrypting the initial anti-forgery field to obtain a random number, the numeric field and an encoded field; decoding the encoded field to obtain a text field; and obtaining a verification result of the product information by comparing the product information with the numeric field and the text field.

In another aspect of the present disclosure, an electronic device is provided, including: one or more processors; a storage device for storing one or more programs, where the one or more programs are configured to, when executed by the one or more processors, cause the one or more processors to perform the methods described in the present disclosure.

In another aspect of the present disclosure, a computer-readable storage medium having computer-executable instructions therein is provided, and the instructions when executed are configured to implement the methods described in the present disclosure.

In another aspect of the present disclosure, a computer program product containing computer-executable instructions is provided, and the instructions when executed are configured to implement the methods described in the present disclosure.

### BRIEF DESCRIPTION OF THE DRAWINGS

The above and other objectives, features and advantages of the present disclosure will be more apparent through the following descriptions of embodiments of the present disclosure with reference to the accompanying drawings. In the accompanying drawings:

FIG. 1 schematically shows an exemplary system architecture to which a method and apparatus of generating an anti-forgery information and a method and apparatus of verifying a product may be applied according to embodiments of the present disclosure;

FIG. 2 schematically shows a flowchart of a method of generating an anti-forgery information according to embodiments of the present disclosure;

FIG. 3 schematically shows an example diagram of a method of generating an anti-forgery information according to embodiments of the present disclosure;

FIG. 4A schematically shows an example diagram of a method of generating an anti-forgery information according to other embodiments of the present disclosure;

FIG. 4B schematically shows an example diagram of a method of generating an anti-forgery information according to still other embodiments of the present disclosure;

FIG. 5 schematically shows an example diagram of encrypting a field to be processed according to embodiments of the present disclosure;

FIG. 6 schematically shows an example diagram of a method of generating an anti-forgery information according to yet other embodiments of the present disclosure;

FIG. 7 schematically shows a flowchart of a method of verifying a product according to embodiments of the present disclosure;

FIG. 8 schematically shows an example diagram of a method of verifying a product according to embodiments of the present disclosure;

FIG. 9 schematically shows a block diagram of an apparatus of generating an anti-forgery information according to embodiments of the present disclosure;

FIG. 10 schematically shows a block diagram of an apparatus of verifying a product according to embodiments of the present disclosure; and

FIG. 11 schematically shows a block diagram of an electronic device suitable for implementing the method of generating the anti-forgery information and the method of verifying the product according to embodiments of the present disclosure.

### DETAILED DESCRIPTION OF EMBODIMENTS

Embodiments of the present disclosure will be described below with reference to the accompanying drawings. However, it should be understood that these descriptions are just exemplary and are not intended to limit the scope of the present disclosure. In the following detailed description, for ease of interpretation, many specific details are set forth to provide comprehensive understanding of embodiments of the present disclosure. However, it is clear that one or more embodiments may also be implemented without these specific details. In addition, in the following description, descriptions of well-known structures and technologies are omitted to avoid unnecessarily obscuring concepts of the present disclosure.

Terms are used herein for the purpose of describing specific embodiments only and are not intended to limit the present disclosure. The terms “including”, “containing”, etc. used herein indicate the presence of the feature, step, operation and/or component, but do not exclude the presence or addition of one or more other features, steps, operations or components.

All terms used herein (including technical and scientific terms) have the meanings generally understood by those skilled in the art, unless otherwise defined. It should be noted that the terms used herein shall be interpreted to have meanings consistent with the context of this specification, and shall not be interpreted in an idealized or overly rigid manner.

In a case of using the expression similar to “at least one of A, B and C”, it should be explained according to the meaning of the expression generally understood by those skilled in the art (for example, “a system including at least one of A, B and C” should include but not be limited to a system including A alone, a system including B alone, a system including C alone, a system including A and B, a system including A and C, a system including B and C, and/or a system including A, B and C). In a case of using the expression similar to “at least one of A, B or C”, it should be explained according to the meaning of the expression generally understood by those skilled in the art (for example, “a system including at least one of A, B or C” should include but not be limited to a system including A alone, a system including B alone, a system including C alone, a system including A and B, a system including A and C, a system including B and C, and/or a system including A, B and C).

Anti-forgery technology is currently an effective means to protect legitimate interests of genuine manufacturers and consumers. In a related art, it is generally to paste a static security identification, such as a security label, on a product, and then check a security code on the security label using the Internet to verify authenticity of the product. However, such security label fixed to the product may not vary and may be easily deciphered and peculated.

Therefore, embodiments of the present disclosure provide a method of generating an anti-forgery information. For example, a classification is performed on a product information according to a field type of the product information, so as to obtain a numeric field and a text field; the text field is encoded to obtain an encoded field; a field to be processed is generated according to a random number, the numeric field and the encoded field; the field to be processed is encrypted to obtain an initial anti-forgery field; a target anti-forgery information is generated according to the initial anti-forgery field and the numeric field.

According to embodiments of the present disclosures, since the initial anti-forgery field is obtained by encrypting the random number, the numeric field and the encoded field, it is possible to dynamically generate a new field to be processed according to a real-time random number, the numeric field and the encoded field in each use of the anti-forgery information. Therefore, a dynamic update of the target anti-forgery information may be achieved, and an anti-forgery effect may be improved.

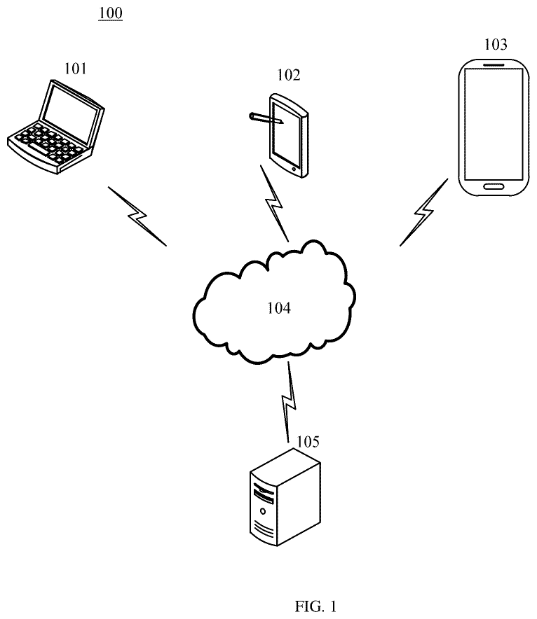

FIG. 1 schematically shows an exemplary system architecture to which a method and apparatus of generating an anti-forgery information and a method and apparatus of verifying a product may be applied according to embodiments of the present disclosure.

It should be noted that FIG. 1 is just an example of the system architecture to which embodiments of the present disclosure may be applied, so as to help those skilled in the art understand technical contents of the present disclosure. However, it does not mean that embodiments of the present disclosure may not be applied to other devices, systems, environments or scenarios. For example, in other embodiments, the exemplary system architecture to which a method and apparatus of detecting an object and a method and apparatus of training a deep learning model may be applied may include a terminal device, but the terminal device may implement the method and apparatus of detecting the object and the method and apparatus of training the deep learning model without interacting with a server.

As shown in FIG. 1, a system architecture 100 according to such embodiments may include a first terminal device 101, a second terminal device 102, a third terminal device 103, a network 104 and a server 105. The network 104 is a medium for providing a communication link between the terminal devices 101, 102, 103 and the server 105. The network 104 may include various connection types, such as wired and/or wireless communication links, etc.

The first terminal device 101, the second terminal device 102 and the third terminal device 103 may be used by a user to interact with the server 105 through the network 104 to receive or send messages, etc. The first terminal device 101, the second terminal device 102 and the third terminal device 103 may be installed with various communication client applications, such as shopping applications, web browser applications, search applications, instant messaging tools, email clients and/or social platform software, etc. (just for example).

The first terminal device 101, the second terminal device 102 and the third terminal device 103 may be various electronic devices having display screens and supporting web browsing, including but not limited to smart phones, tablet computers, laptop computers, and desktop computers, etc.

The server 105 may be various types of servers providing various services. For example, the server 105 may be a cloud server, also known as a cloud computing server or a cloud host, which is a host product in a cloud computing service system to solve shortcomings of difficult management and weak service scalability existing in a conventional physical host and VPS (Virtual Private Server) service. The server 105 may also be a server of a distributed system or a server combined with a block-chain.

It should be noted that the method of generating the anti-forgery information provided in embodiments of the present disclosure may generally be performed by the first terminal device 101, the second terminal device 102 or the third terminal device 103. Accordingly, the apparatus of generating the anti-forgery information provided in embodiments of the present disclosure may also be arranged in the first terminal device 101, the second terminal device 102 or the third terminal device 1033.

Alternatively, the method of generating the anti-forgery information provided in embodiments of the present disclosure may generally be performed by the server 105. Accordingly, the apparatus of generating the anti-forgery information provided in embodiments of the present disclosure may also be arranged in the server 105. The method of generating the anti-forgery information provided in embodiments of the present disclosure may also be performed by a server or server cluster that is different from the server 105 and capable of communicating with the first terminal device 101, the second terminal device 102, the third terminal device 103 and/or the server 105. Accordingly, the apparatus of generating the anti-forgery information provided in embodiments of the present disclosure may also be arranged in a server or server cluster that is different from the server 105 and capable of communicating with the first terminal device 101, the second terminal device 102, the third terminal device 103 and/or the server 105.

It should be noted that the method of verifying the product provided in embodiments of the present disclosure may generally be performed by the server 105. Accordingly, the apparatus of verifying the product provided in embodiments of the present disclosure may also be arranged in the server 105. The method of verifying the product provided in embodiments of the present disclosure may also be performed by a server or server cluster that is different from the server 105 and capable of communicating with the first terminal device 101, the second terminal device 102, the third terminal device 103 and/or the server 105. Accordingly, the apparatus of verifying the product provided in embodiments of the present disclosure may also be arranged in a server or server cluster that is different from the server 105 and capable of communicating with the first terminal device 101, the second terminal device 102, the third terminal device 103 and/or the server 105.

Alternatively, the method of verifying the product provided in embodiments of the present disclosure may generally be performed by the first terminal device 101, the second terminal device 102 or the third terminal device 103. Accordingly, the apparatus of training the deep learning model provided in embodiments of the present disclosure may also be arranged in the first terminal device 101, the second terminal device 102 or the third terminal device 103.

It should be understood that the number of terminal devices, networks and servers shown in FIG. 1 are just schematic. According to implementation needs, any number of terminal devices, networks and servers may be provided.

It should be noted that a sequence number of each operation in the following methods is just used to represent the operation for ease of description, and should not be regarded as indicating an execution order of each operation. Unless explicitly stated, the methods do not need to be performed exactly in the order shown.

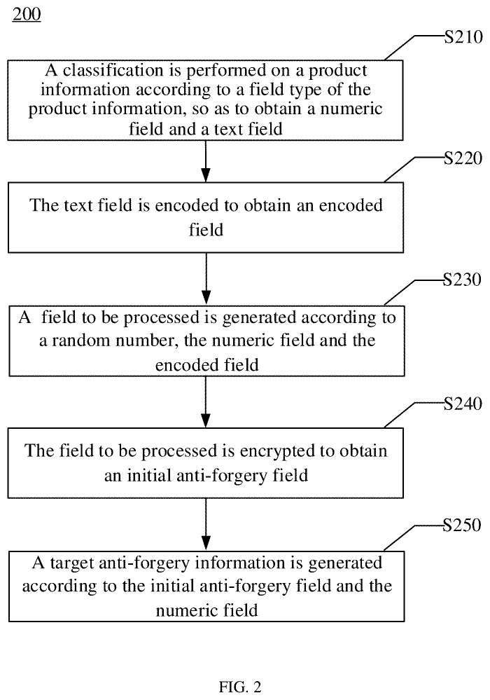

FIG. 2 schematically shows a flowchart of a method of generating an anti-forgery information according to embodiments of the present disclosure.

As shown in FIG. 2, a method 200 includes operations S210 to S250.

In operation S210, a classification is performed on a product information according to a field type of the product information, so as to obtain a numeric field and a text field.

In operation S220, the text field is encoded to obtain an encoded field.

In operation S230, a field to be processed is generated according to a random number, the numeric field and the encoded field.

In operation S240, the field to be processed is encrypted to obtain an initial anti-forgery field.

In operation S250, a target anti-forgery information is generated according to the initial anti-forgery field and the numeric field.

According to embodiments of the present disclosure, the product information may include a product serial number. The product serial number is generally a unique identification number for a product, which is compiled according to a product type, a product name, a product model, a product batch, a production time and other information when the product has been produced by a manufacturer and before the product leaves the factory. The product information may generally consist of letters and numbers, such as “AAA111BB22”.

According to embodiments of the present disclosure, in order to facilitate an information traceability when a product has a quality problem, the manufacturer may further add a manufacturer identification to the product information. For example, a manufacturer in place A may have an identification of “0D3”, then the product information may be “AAA111BB220D3”.

According to embodiments of the present disclosure, in order to increase a difficulty of deciphering the anti-forgery information, it is possible to irregularly upgrade the method of generating the anti-forgery information. In this case, there may be differences in the method of generating the anti-forgery information for different batches of products. Therefore, when verifying a product, it is needed to firstly identify a version of the method of generating the anti-forgery information, so that the anti-forgery information may be parsed using a corresponding verification method to achieve a valid verification of the product. Therefore, a version identification of an anti-forgery algorithm may be further added to the product information. For example, the version identification of the method of generating the anti-forgery information may be “PC1”, then the product information may be “AAA111BB220D3PC1”.

For example, the product information may be “AAA111BB22”. A classification may be performed on the product information according to the field type of the product information to obtain numeric fields “111” and “22” and text fields “AAA” and “BB”.

According to embodiments of the present disclosure, the text field may be encoded using an encoding dictionary, in which numbers corresponding to each text may be stored. For example, letter A may correspond to number “0”, and letter B may correspond to number “111”. The text field “AAA” may be encoded to obtain an encoded field “000”, and the text field “BB” may be encoded to obtain an encoded field “111111”.

According to embodiments of the present disclosure, the encoded field may be combined with the numeric field to form an all-numeric field of the product information according to an initial position of the text field in the product information.

For example, the product information may be “AAA111BB22”. After the text field is encoded, the all-numeric field of the product information formed by the encoded field and the numeric field may be “00011111111122”.

According to embodiments of the present disclosure, the random number may be randomly generated using a random number seed. The random number seed may be a real-time moment information, or may be an analog signal acquired by an analog signal acquisition port of an embedded system in an electronic product.

According to embodiments of the present disclosure, a position of the random number in the field to be processed may be pre-configured. For example, for the position of the random number in the field to be processed, the random number may be added before a first byte, after a last byte, or between an m^{th} byte and an (m+1)^{th} byte, where m may be greater than 1 and less than or equal to a total number of bytes. The total number of bytes may be the number of bytes in the all-numeric field.

For example, the all-numeric field of the product information may be “00011111111122”, the random number may be “45”, and the pre-configured position of the random number in the field to be processed may be between a third byte and a fourth byte. Then a field to be processed “0004511111111122” may be obtained.

According to embodiments of the present disclosure, the field to be processed may be encrypted using a symmetric encryption algorithm, such as a data encryption algorithm (DES), to obtain an initial anti-forgery field. The field to be processed may also be encrypted using an asymmetric encryption algorithm, such as RSA (Rivest Shamir Adleman) algorithm for public key cryptography, to obtain an initial anti-forgery field. A specific type of the encryption algorithm is not specifically limited in embodiments of the present disclosure.

According to embodiments of the present disclosure, an embedding position of the numeric field may be pre-configured. For example, the embedding position of the numeric field may be before a first byte, after a last byte, or between an m^{th} byte and an (m+1)^{th} byte, where m may be greater than 1 and less than or equal to a total number of bytes. The total number of bytes may be the number of bytes in the all-numeric field. In a case that the product information includes a plurality of numeric fields, different embedding positions may be configured for different numeric fields.

For example, the product information may be “AAA111BB22”. After the field to be processed “0004511111111122” is encrypted, an initial anti-forgery field “EJ7B5NYJGV677P529” may be obtained. In the product information, a first numeric field is “111”, and a second numeric field is “22”. The embedding position of the numeric field may include inserting the first numeric field between a third byte and a fourth byte of the initial anti-forgery field and inserting the second numeric field after the last byte of the initial anti-forgery field. After the numeric fields are sequentially embedded into the initial anti-forgery field according to the embedding positions of the numeric fields, a target anti-forgery information “EJ7111B5NYJGV677P52922” may be obtained.

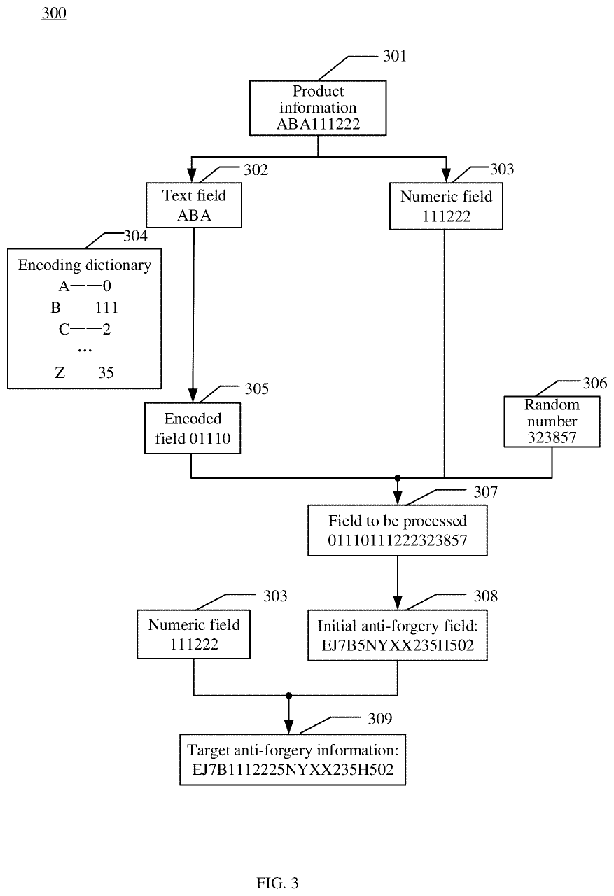

FIG. 3 schematically shows an example diagram of a method of generating an anti-forgery information according to embodiments of the present disclosure.

As shown in FIG. 3, in embodiment 300, a classification is performed on a product information 301 “ABA111222” to obtain a text field 302 “ABA” and a numeric field 303 “111222”. The text field 302 is encrypted using an encoding field 304 to obtain an encoded field 305 “01110”. A field to be processed 307 “01110111222323857” may be obtained according to the encoded field 305 “0110”, the numeric field 303 “111222” and a random number 306 “32857”. The field to be processed 307 is encrypted to obtain an initial anti-forgery field 308 “EJ7B5NYXX235H502”. A target anti-forgery information 309

“EJ7B1112225NYXX235H502” may be obtained according to the numeric field 303 and the initial anti-forgery field 308.

According to embodiments of the present disclosure, since the initial anti-forgery field is obtained by encrypting the random number, the numeric field and the encoded field, the embedding position of the random number in the field to be processed and the embedding position of the numeric field in the initial anti-forgery field may be flexibly configured. In each use of the anti-forgery information, it is possible to dynamically generate a new field to be processed according to a real-time random number, the numeric field and the encoded field, so that a dynamic update of the target anti-forgery information may be achieved, and the anti-forgery effect may be improved.

Although adding a random number to the field of the product information may increase the difficulty of deciphering the anti-forgery information, the field to be processed may have different field lengths after the random number is added to the field of the product information because a field length of the random number is not fixed. When encrypting the field to be processed, different computational resources may be required for the fields to be processed having different field lengths. In order to meet requirements of the field to be processed for the computing resource, the computing resource may be configured according to a required computing power for a longest field. However, it may waste a resource space and increase a cost of anti-forgery.

Therefore, in embodiments of the present disclosure, the field to be processed may be limited to a fixed field length to ensure a uniformity of a resource allocation.

According to embodiments of the present disclosure, generating the field to be processed according to the random number, the numeric field and the encoded field may include the following operations: obtaining a field length of the product information according to the numeric field and the encoded field; obtaining a target random field from the random number according to the field length and a field length threshold; generating the field to be processed according to the target random field, the numeric field and the encoded field.

According to embodiments of the present disclosure, obtaining the field length of the product information according to the numeric field and the encoded field may include the following operations: determining a length of the numeric field according to the numeric field; determining a length of the encoded field according to the encoded field; obtaining the field length of the product information according to the length of the numeric field and the length of the encoded field.

According to embodiments of the present disclosure, a plurality of numeric fields may be included, and the length of the numeric field may be a sum of the lengths of the plurality of numeric fields.

For example, the all-numeric field of the product information may be “00011111111122”. A byte length of the numeric field “111” may be 3, and a byte length of the numeric field “22” may be 2, then the byte length of the numeric fields may be 5.

According to embodiments of the present disclosure, a plurality of encoded fields may be included, and the length of the encoded field may be a sum of the lengths of the plurality of encoded fields.

For example, the all-numeric field of the product information may be “00011111111122”. A byte length of the encoded field “000” may be 3, and a byte length of the encoded field “111111” may be 6, then the byte length of the encoded fields may be 9.

According to embodiments of the present disclosure, the field length of the product information may be obtained according to the sum of the lengths of the plurality of numeric fields and the sum of the lengths of the plurality of encoded fields.

For example, the sum of the lengths of the plurality of numeric fields may be 5, and the sum of the lengths of the plurality of encoded fields may be 9, then the field length of the product information field may be 14.

According to embodiments of the present disclosure, by fixing the field length of the field to be processed through the field length threshold, it is possible to unify a demand for the computing resources in a process of generating the target anti-forgery information, so as to flexibly configure the field length threshold according to a current configuration of computing resources.

According to embodiments of the present disclosure, obtaining the target random field from the random number according to the field length and the field length threshold may include the following operations: determining a target number of bytes according to the field length and the field length threshold; obtaining, based on a field query strategy, the target random field from the random number according to the target number of bytes.

According to embodiments of the present disclosure, the field length threshold may be pre-configured, which may be, for example, 20. The target number of bytes may be determined according to a difference value between the field length threshold and the field length of the product information. Then, based on the field query strategy, the target random field may be obtained from the random number according to the target number of bytes.

For example, the field length of the product information may be 14, and the field length threshold may be 20, then the target number of bytes may be 6. The random number may be “13592055”, and the field query strategy may be: starting from a second field and querying from left to right, then the target random field “359205” may be obtained.

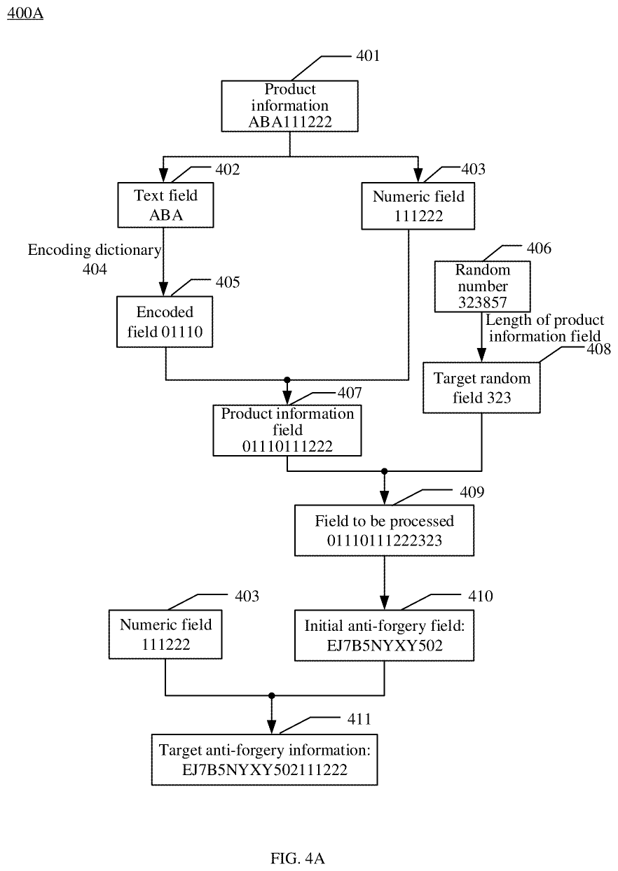

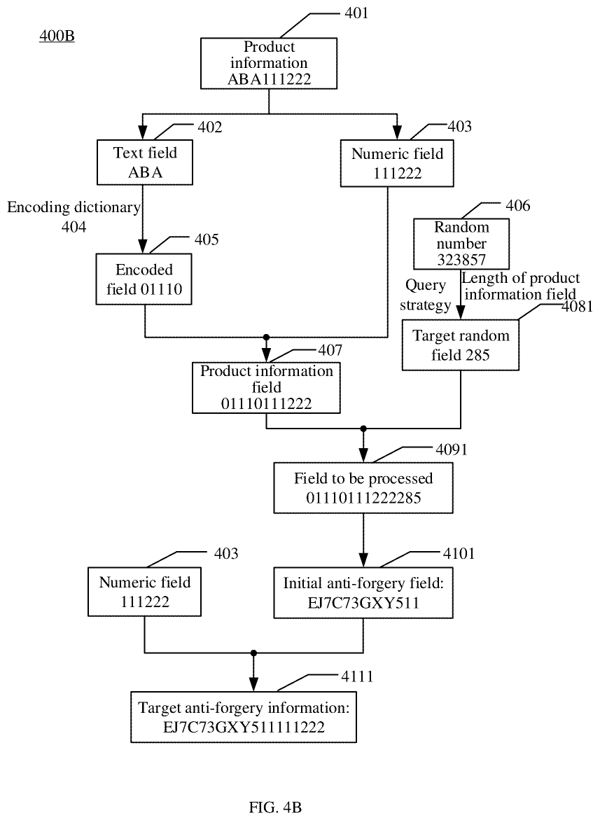

FIG. 4A schematically shows an example diagram of a method of generating an anti-forgery information according to other embodiments of the present disclosure.

As shown in FIG. 4A, in embodiment 400A, a classification is performed on a product information 401 “ABA111222” to obtain a text field 402 “ABA” and a numeric field “111222”. The text field 402 is encoded using an encoding field 404 to obtain an encoded field 405 “0110”. A product information field 407 “01110111222” may be obtained according to the numeric field 403 and the encoded field 405. A target number of bytes may be determined according to a length of the product information field and a field length threshold, and a target random field 408 “323” may be obtained from a random number 406 “323857” according to the target number of bytes. A field to be processed 409 “01110111222323” may be obtained according to the target random field 408 and the product information field 407. The field to be processed 409 is encrypted to obtain an initial anti-forgery field 410 “EJ7B5NYXY502”. A target anti-forgery information 411 “EJ7B5NYXY502111222” may be obtained according to the numeric field 403 and the initial anti-forgery field 410.

According to embodiments of the present disclosure, obtaining the target random field from the random number according to the target number of bytes based on the field query strategy may include the following operations: determining a query start position and a query direction based on the field query strategy; determining a query end position according to the query start position, the query direction and the target number of bytes; retrieving the target random field from the random number according to the query start position and the query end position.

According to embodiments of the present disclosure, the field query strategy may include a sequential query. The sequential query may be starting from an i^{th} field in the random number and sequentially querying an (i+1)^{th} field, an (i+2)^{th} field . . . an (i+j)^{th} field, where i and j may be integers greater than or equal to 1.

For example, the field query strategy may be starting from a second field of the random number and sequentially querying from left to right. The query start position may be the second field, and the query direction may be from left to right. The target number of bytes may be 6, then the query end position may be a seventh field.

According to embodiments of the present disclosure, the field query strategy may also be a skip query. The skip query may be starting from an i^{th} field in the random number and sequentially query an (i+2)^{th} field, an (i+4)^{th} field . . . an (i+q)^{th} field according to a predetermined skip interval such as 2, where i and q may be integers greater than or equal to 1.

For example, the field query strategy may be starting from a second field of the random number and querying from left to right in a skip manner, and the skip interval may be 2. The query start position may be the second field, and the query direction may be from left to right. The target number of bytes may be 3, then the query end position may a sixth field.

FIG. 4B schematically shows an example diagram of a method of generating an anti-forgery information according to still other embodiments of the present disclosure.

As shown in FIG. 4B, in embodiment 400A, a classification is performed on a product information 401 “ABA111222” to obtain a text field 402 “ABA” and a numeric field “111222”. The text field 402 is encoded using an encoding field 404 to obtain an encoded field 405 “0110”. A product information field 407 “01110111222” may be obtained according to the numeric field 403 and the encoded field 405. A target number of bytes may be determined according to a length of the product information field and a field length threshold. A target random field 40111 “285” may be obtained from a random number 406 “323857” according to the target number of bytes based on a query strategy. A field to be processed 4091 “01110111222285” may be obtained according to the target random field 408 and the product information field 407. The field to be processed 409 may be encrypted to obtain an initial anti-forgery field 4101 “EJ7C73GXY511”. A target anti-forgery information 4111 “EJ7C73GXY511111222” may be obtained according to the numeric field 403 and the initial anti-forgery field 4101.

According to embodiments of the present disclosure, by configuring different field query strategies, it is possible to obtain the target random field from the random number according to the query strategy, which increases the difficulty of deciphering the random number.

According to embodiments of the present disclosure, generating the field to be processed according to the target random field, the numeric field and the encoded field may include the following operations: generating an information code according to the numeric field and the encoded field; determining an embedding position information of the target random field; embedding the target random field into the information code according to the embedding position information, so as to generate the field to be processed.

According to embodiments of the present disclosure, the information code may be an all-numeric field of the product information. The embedding position of the target random field may be pre-configured. For example, the embedding position of the target random field may be between a sixth byte and a seventh byte of the information code.

For example, the information code may be “00011111111122”, the target random field may be “359205”, and the embedding position of the target random field may be between a sixth byte and a seventh byte of the information code. The target random field “359205” may be embedded between the sixth byte and the seventh byte of the information code to obtain the field to be processed “00011135920511111122”.

According to embodiments of the present disclosure, the embedding position information of the target random field may also be queried according to the random number. For example, it is possible to construct a mapping relationship between the random field and the embedding position of the target random field, and query the embedding position of the target random field according to the target random field and the above-mentioned mapping relationship.

According to embodiments of the present disclosure, an embedding position may be determined by querying the mapping relationship between the random field and the embedding position of the target random field. For example, the target random field may be “359205”. By querying the mapping relationship between the target random field and the embedding position of the target random field, it may be obtained that the embedding position of the target random field is “between a second byte and a third byte”.

For example, the information code may be “00011111111122”, the target random field may be “359205”, and the field to be processed “00359205011111111122” may be obtained according to the embedding position.

According to embodiments of the present disclosure, it is possible to determine a plurality of embedding positions by querying the mapping relationship between the random field and the embedding position of the target random field. For example, the target random field may be “359205”. By querying the mapping relationship between the target random field and the embedding position of the target random field, it may be obtained that the embedding position corresponding to the field “359” is “between a second byte and a third byte”, and the embedding position corresponding to field “205” is “between an eighth byte and a ninth byte”.

For example, the information code may be “00011111111122”, the target random field may be “359205”, and the field to be processed “003590111205111122” may be obtained according to the embedding position mentioned above.

According to embodiments of the present disclosure, by determining the embedding position of the target random field, it is possible to improve a variability of the field to be processed generated from the target random field and the information code, thereby increasing the difficulty of deciphering the target anti-forgery information.

In order to increase the difficulty of deciphering the target anti-forgery information, it is possible to determine a target key using the random number, thereby achieving a randomness of the encryption process.

According to embodiments of the present disclosure, encrypting the field to be processed to obtain the initial anti-forgery field may include the following operations: determining a target key according to the random number by querying the anti-forgery information database; encrypting the field to be processed by using the target key, so as to obtain the initial anti-forgery field.

According to embodiments of the present disclosure, the anti-forgery information database may include a mapping relationship between random numbers and key information. For example, a key corresponding to the random number “10D” may be a data encryption key in a symmetric encryption algorithm, and a key corresponding to the random number “MD8” may be a public key in an asymmetric encryption algorithm.

According to embodiments of the present disclosure, encrypting the field to be processed by using the target key so as to obtain the initial anti-forgery field may include the following operations: determining a target encryption algorithm according to a type of the target key; encrypting the field to be processed using the target key according to the target encryption algorithm, so as to obtain the initial anti-forgery field.

For example, the field to be processed may be “00359011111205111122”, and the random number may be “359205”. A public key of the asymmetric encryption algorithm may be obtained according to the random number by querying the anti-forgery information database. The field to be processed may be encrypted using the public key according to the RSA algorithm, so as to obtain the initial anti-forgery field.

The encryption algorithms in embodiments of the present disclosure are currently mature encryption technologies, and an execution process of the encryption algorithms will not be described in detail here.

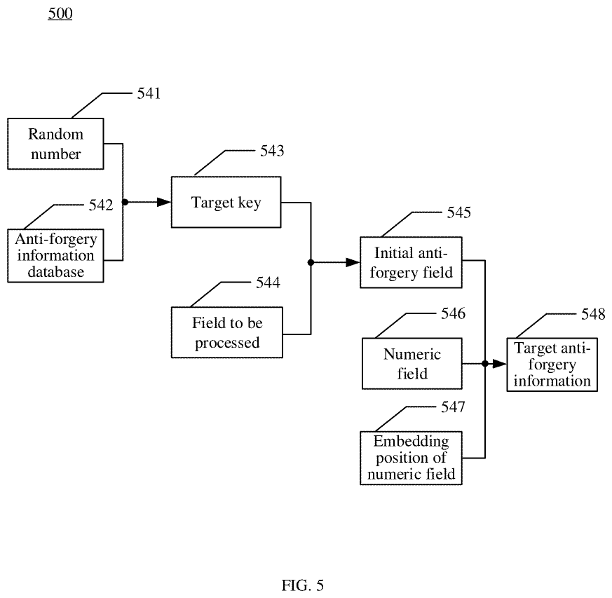

FIG. 5 schematically shows an example diagram of encrypting a field to be processed according to embodiments of the present disclosure.

As shown in FIG. 5, in embodiment 500, a target key 543 is obtained according to a random number 541 by querying an anti-forgery information database 542. A field to be processed 544 is encrypted using the target key 543 to obtain an initial anti-forgery field 545. A target anti-forgery information 548 is obtained according to the initial anti-forgery field 545, a numeric field 546, and an embedding position 547 of the numeric field.

According to embodiments of the present disclosure, by randomly determining the encryption algorithm through the random number, it is possible to increase a randomness of the encryption process and improve the difficulty of deciphering the target anti-forgery information.

According to embodiments of the present disclosure, generating the target anti-forgery information according to the initial anti-forgery field and the numeric field may include the following operations: determining an embedding position information of the numeric field; embedding the numeric field into the initial anti-forgery field according to the embedding position information, so as to generate the target anti-forgery information.

According to embodiments of the present disclosure, the method of determining the embedding position information of the numeric field is similar to the method of determining the embedding position information of the target random field as described above. It is possible to pre-configure a fixed embedding position, or obtain the embedding position of the numeric field by querying the mapping relationship between the random number and the embedding position of the numeric field by using the random number, which will not be repeated here.

According to embodiments of the present disclosure, embedding the numeric field into the initial anti-forgery field according to the embedding position information so as to generate the target anti-forgery information may include the following operations: embedding the numeric field into the initial anti-forgery field according to the embedding position information so as to obtain the target anti-forgery field; determining a display type of the target anti-forgery field according to the product information; processing the target anti-forgery field based on the display type, so as to obtain the target anti-forgery information.

According to embodiments of the present disclosure, the target anti-forgery information may vary dynamically and may generally be displayed through a visual interface. However, different display manners may be selected due to different resolutions of visual interfaces of different products.

According to embodiments of the present disclosure, the product information may include a resolution information of the visual interface of the product. The display type of the target anti-forgery field may be determined according to the resolution information by querying a corresponding relationship between the display type and a resolution threshold. For example, for a product of which the visual interface has a low resolution, the target anti-forgery field may be directly displayed. For a product of which the visual interface has a high resolution, the target anti-forgery field may be converted into a barcode or a quick response code for display.

According to embodiments of the present disclosure, for the target anti-forgery field that needs to be converted into a barcode or a quick response code, the target anti-forgery field may be processed using a barcode or quick response code generation technology according to a corresponding relationship between each character in the target anti-forgery field and a barcode graphic or a quick response code graphic, so as to obtain a barcode image or a quick response code graphic corresponding to content of the target anti-forgery field as the target anti-forgery information.

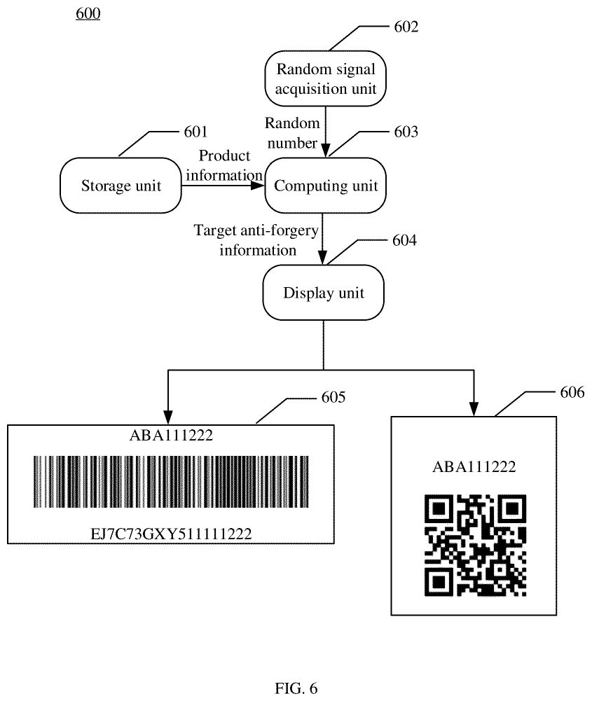

FIG. 6 schematically shows an example diagram of a method of generating an anti-forgery information according to other embodiments of the present disclosure.

As shown in FIG. 6, in embodiment 600, a storage unit 601, a random signal acquisition unit 602, a computing unit 603 and a display unit 604 may be processing units in an embedded system of a product. When running the method of generating the anti-forgery information of embodiments of the present disclosure, the computing unit 603 may acquire a product information from the storage unit 601 and acquire a random number from the random signal acquisition unit. The random signal acquisition unit may be any of a timer unit, a timing unit or an analog signal acquisition unit. The random signal acquisition unit may use a random signal acquired from the timer unit, the timing unit or the analog signal acquisition unit as a random number seed, which is input into an embedded random number generator to generate a random number. The computing unit 603 may generate a target anti-forgery information using the product information and the random number by performing the method of generating the anti-forgery information in embodiments of the present disclosure. The display unit 604 may determine a final display manner of the target anti-forgery information, such as a barcode 605 or a quick response code 606, according to a product resolution or other configuration information.

Barcode generation technology and quick response code generation technology are currently mature technologies, and a process of processing the target anti-forgery field using the barcode generation technology or the quick response code generation technology will not be described in detail here.

According to embodiments of the present disclosure, by determining the embedding position of the numeric field, it is possible to improve the variability of the target anti-forgery information generated from the numeric field and the initial anti-forgery field, thereby increasing the difficulty of deciphering the target anti-forgery information.

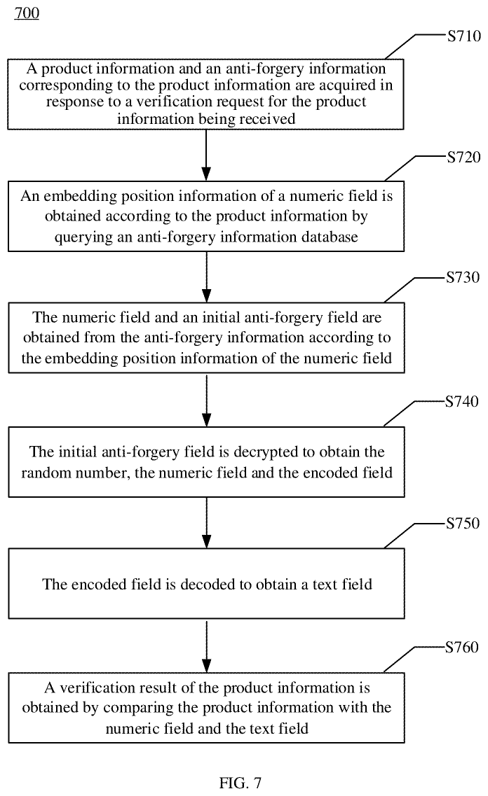

FIG. 7 schematically shows a flowchart of a method of verifying a product according to embodiments of the present disclosure.

As shown in FIG. 7, a method 700 of verifying a product may include operations S710 to S760.

In operation S710, a product information and an anti-forgery information corresponding to the product information are acquired in response to a verification request for the product information being received.

In operation S720, an embedding position information of a numeric field is obtained according to the product information by querying an anti-forgery information database.

In operation S730, the numeric field and an initial anti-forgery field are obtained from the anti-forgery information according to the embedding position information of the numeric field.

In operation S740, the initial anti-forgery field is decrypted to obtain the random number, the numeric field and the encoded field;

In operation S750, the encoded field is decoded to obtain a text field.

In operation S760, a verification result of the product information is obtained by comparing the product information with the numeric field and the text field.

According to embodiments of the present disclosure, the product may be any terminal device such as a splicing electronic screen. When a select operation for verifying a product is triggered by a user on a terminal device, an anti-forgery information may be generated according to the method of generating the anti-forgery information provided in embodiments of the present disclosure through the embedded system embedded in the product as shown in FIG. 6. The anti-forgery information and the product information may be sent to the server, and the method of verifying the product in embodiments of the present disclosure may be performed by the server.

According to embodiments of the present disclosure, the anti-forgery information database may store anti-forgery algorithm-related information corresponding to different product information, such as a version identification of an anti-forgery algorithm information. Each version of the anti-forgery algorithm information may include an embedding position information of a numeric field, an embedding position information of a random number, a key information, a decryption algorithm information, etc.

For example, the product information may be “AAA111”, and the anti-forgery information may be “EJ7C73GXY511111222”. By querying the anti-forgery information, it may be obtained that the embedding position information of the numeric field is between a tenth byte and an eleventh byte. From the anti-forgery information, a numeric field “111” and an initial anti-forgery field “EJ7C73GXY511222” may be obtained.

According to embodiments of the present disclosure, decrypting the initial anti-forgery field to obtain the random number, the numeric field and the encoded field may include the following operations: obtaining the random number and a target key according to the product information by querying the anti-forgery information database; decrypting the initial anti-forgery field using the target key to obtain the random number, the numeric field and the encoded field.

According to embodiments of the present disclosure, in order to increase the randomness of the encryption process, the encryption algorithm for generating the anti-forgery information may be queried through the random number. Therefore, the target key may also be obtained according to the random number by querying the corresponding relationship between the random number and the key.

According to embodiments of the present disclosure, decrypting the initial anti-forgery field using the target key to obtain the random number, the numeric field and the encoded field may include the following operations: determining a target encryption algorithm according to a type of the target key; decrypting the initial anti-forgery field using the target key based on the target encryption algorithm, so as to obtain the random number, the numeric field and the encoded field.

According to embodiments of the present disclosure, in a case that the target encryption algorithm is a symmetric encryption algorithm, the same key is used in the encryption process and the decryption process. In a case that the target encryption algorithm is an asymmetric algorithm, different keys are used in the encryption process and the decryption process. For example, a public key may be used for encryption, and then a private key corresponding to the public key may be used for decryption.

For example, according to the product information, it may be obtained by querying the anti-forgery information database that the random number is “385” and the target key is a key of the data encryption algorithm. The data encryption algorithm is a symmetric encryption algorithm, and the same key is used in the encryption process and the decryption process. Therefore, the initial anti-forgery field may be decrypted using that key to obtain “000111385”, where “111” is the numeric field in the product information, “000” is the encoded field in the product information, and “385” is the random number.

According to embodiments of the present disclosure, the encoded field may be decoded using the encoding field to obtain the text field “AAA”. Therefore, by decrypting and decoding the anti-forgery information, it is obtained that the numeric field of the product information is “111”, and the text field is “AAA”.

According to embodiments of the present disclosure, the embedding position of the numeric field and the embedding position of the random number may be obtained by querying the anti-forgery information database. Therefore, the decryption and decoding of the anti-forgery information may be performed without changing the position of the numeric field and the position of the text field in the initial product information. The verification result of the product information may be obtained by comparing the product information with the numeric field and the text field.

According to embodiments of the present disclosure, if the numeric field and the text field in the product information are identical to the numeric field and the text field obtained by processing the anti-forgery information, it may be determined that the verification result of the product information is verification passed. Otherwise, it may be determined that the verification result of the product information is verification failed.

For example, the product information may be “AAA111”, and the numeric field “111” and the text field “AAA” are obtained by processing the anti-forgery information. Then, the verification result of the product information may be verification passed.

In order to improve the anti-forgery effect, it is possible to limit the number of anti-forgery verifications. When the number of verifications exceeds a limited threshold, an alert message may be sent to an operation and maintenance system, and a dynamic generation of anti-forgery information may be stopped.

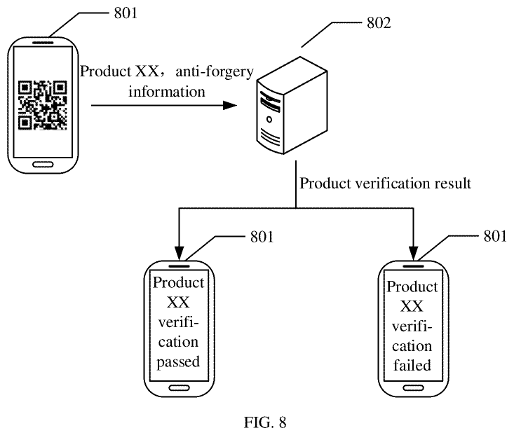

FIG. 8 schematically shows an example diagram of a method of verifying a product according to embodiments of the present disclosure.

As shown in FIG. 8, in embodiment 800, a dynamically generated anti-forgery quick response code may be scanned by the user using a terminal device 801, and an anti-forgery quick response code image may be identified by the terminal device 801 to obtain an anti-forgery information. The product information and the anti-forgery information may be sent to the server 802. The server 802 may process the anti-forgery information according to the product information and the anti-forgery information by using the method of verifying the product provided in embodiments of the present disclosure, so as to obtain a product verification result. The product verification result may be sent to the terminal device and displayed through a visual interface of the terminal device 801. For example, the product verification result may be displayed as product XX verification passed or product XX verification failed.

According to embodiments of the present disclosure, the anti-forgery algorithm-related information corresponding to the product information may be obtained according to the product information by querying the anti-forgery information database, and the verification result of the product information may be obtained by decrypting and decoding the anti-forgery information. Since the anti-forgery information is dynamically generated, a credibility of the product verification result may be effectively improved.

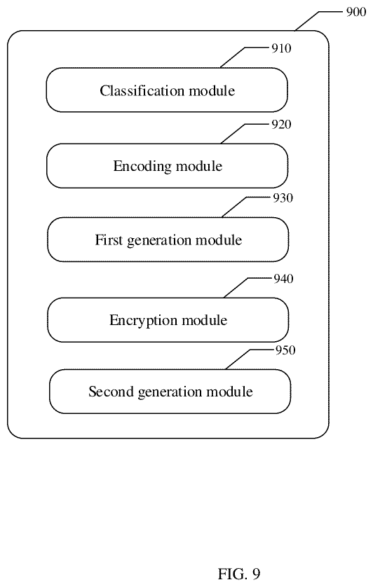

FIG. 9 schematically shows a block diagram of an apparatus of generating an anti-forgery information according to embodiments of the present disclosure.

As shown in FIG. 9, an apparatus 900 of generating an anti-forgery information may include a classification module 910, an encoding module 920, a first generation module 930, an encryption module 940, and a second generation module 950.

The classification module 910 is used to perform a classification on a product information according to a field type of the product information, so as to obtain a numeric field and a text field.

The encoding module 920 is used to encode the text field to obtain an encoded field.

The first generation module 930 is used to generate a field to be processed, according to a random number, the numeric field and the encoded field.

The encryption module 940 is used to encrypt the field to be processed to obtain an initial anti-forgery field.

The second generation module 950 is used to generate a target anti-forgery information according to the initial anti-forgery field and the numeric field.

According to embodiments of the present disclosure, the first generation module 930 may include a first obtaining sub-module, a second obtaining sub-module and a first generation sub-module. The first obtaining sub-module is used to obtain a field length of the product information according to the numeric field and the encoded field. The second obtaining sub-module is used to obtain a target random field from the random number according to the field length and a field length threshold. The first generation sub-module is used to generate the field to be processed according to the target random field, the numeric field and the encoded field.

According to embodiments of the present disclosure, the first obtaining sub-module may include a first determination unit, a second determination unit and a first obtaining unit. The first determination unit is used to determine a length of the numeric field according to the numeric field. The second determination unit is used to determine a length of the encoded field according to the encoded field. The first obtaining unit is used to obtain the field length of the product information according to the length of the numeric field and the length of the encoded field.

According to embodiments of the present disclosure, the second obtaining sub-module may include a first determination unit and a second obtaining unit. The third determination unit is used to determine a target number of bytes according to the field length and the field length threshold. The second obtaining unit is used to obtain, based on a field query strategy, the target random field from the random number according to the target number of bytes.

According to embodiments of the present disclosure, the second obtaining unit may include a first determination sub-unit, a second determination sub-unit and a query sub-unit. The first determination sub-unit is used to determine a query start position and a query direction based on the field query strategy. The second determination sub-unit is used to determine a query end position according to the query start position, the query direction and the target number of bytes. The query sub-unit is used to retrieve the target random field from the random number according to the query start position and the query end position.

According to embodiments of the present disclosure, the first generation sub-module may include a first generation unit, a fourth determination unit and a second generation unit. The first generation unit is used to generate an information code according to the numeric field and the encoded field. The fourth determination unit is used to determine an embedding position information of the target random field. The second generation unit is used to embed the target random field into the information code according to the embedding position information, so as to generate the field to be processed.

According to embodiments of the present disclosure, the encryption module may include a first determination sub-module and an encryption sub-module. The first determination sub-module is used to determine a target key according to the random number by querying an anti-forgery information database. The encryption sub-module is used to encrypt the field to be processed by using the target key, so as to obtain the initial anti-forgery field.

According to embodiments of the present disclosure, the encryption sub-module may include a fifth determination unit and an encryption unit. The fifth determination unit is used to determine a target encryption algorithm according to a type of the target key. The encryption unit is used to encrypt the field to be processed by using the target key based on the target encryption algorithm, so as to obtain the initial anti-forgery field.

According to embodiments of the present disclosure, the second generation module may include a second determination sub-module and a second generation sub-module. The second determination sub-module is used to determine an embedding position information of the numeric field. The second generation sub-module is used to embed the numeric field into the initial anti-forgery field according to the embedding position information, so as to generate the target anti-forgery information.

According to embodiments of the present disclosure, the second generation sub-module may include an embedding unit, a sixth determination unit and a processing unit. The embedding unit is used to embed the numeric field into the initial anti-forgery field according to the embedding position information, so as to obtain a target anti-forgery field. The sixth determination unit is used to determine a display type of the target anti-forgery field according to the product information. The processing unit is used to process the target anti-forgery field based on the display type, so as to obtain the target anti-forgery information.

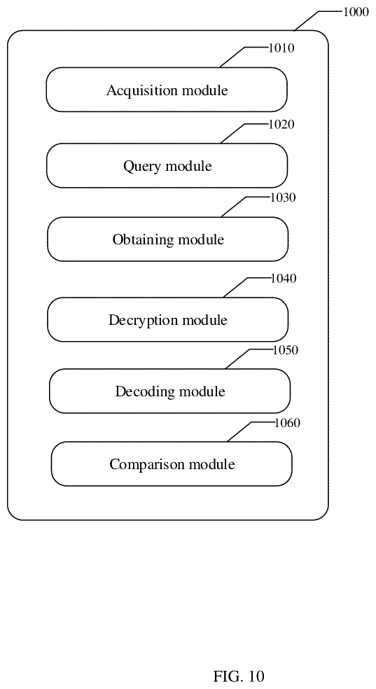

FIG. 10 schematically shows a block diagram of an apparatus of verifying a product according to embodiments of the present disclosure.

As shown in FIG. 10, an apparatus 1000 of verifying a product may include an acquisition module 1010, a query module 1020, an obtaining module 1030, a decryption module 1040, a decoding module 1050 and a comparison module 1060.

The acquisition module 1010 is used to acquire, in response to a verification request for a product information being received, the product information and an anti-forgery information corresponding to the product information. The anti-forgery information is generated using the method of generating the anti-forgery information as described above

The query module 1020 is used to obtain, by querying an anti-forgery information database, an embedding position information of a numeric field according to the product information.

The obtaining module 1030 is used to obtain, from the anti-forgery information, the numeric field and an initial anti-forgery field according to the embedding position information of the numeric field.

The decryption module 1040 is used to decrypt the initial anti-forgery field to obtain a random number, the numeric field and an encoded field.

The decoding module 1050 is used to decode the encoded field to obtain a text field.

The comparison module 1060 is used to obtain a verification result of the product information by comparing the product information with the numeric field and the text field.

According to embodiments of the present disclosure, the decryption module 1040 may include a query sub-module and a decryption sub-module. The query sub-module is used to obtain, by querying the anti-forgery information database, the random number and a target key according to the product information. The decryption sub-module is used to decrypt the initial anti-forgery field by using the target key, so as to obtain the random number, the numeric field and the encoded field.

According to embodiments of the present disclosure, the decryption sub-module may include a seventh determination unit and a decryption unit. The seventh determination unit is used to determine a target encryption algorithm according to a type of the target key. The decryption unit is used to decrypt the initial anti-forgery field by using the target key based on the target encryption algorithm, so as to obtain the random number, the numeric field and the encoded field.

Any number of the modules, sub-modules and units according to embodiments of the present disclosure, or at least part of functions of any number of them may be implemented in one module. Any one or more of the modules, sub-modules and units according to embodiments of the present disclosure may be split into a plurality of modules for implementation. Any one or more of the modules, sub-modules and units according to embodiments of the present disclosure may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by hardware or firmware in any other reasonable manner of integrating or encapsulating the circuit, or may be implemented by any one of three implementation modes of software, hardware and firmware or an appropriate combination thereof. Alternatively, one or more of the modules, sub-modules and units according to embodiments of the present disclosure may be at least partially implemented as a computer program module that, when executed, performs the corresponding functions.

For example, any number of the classification module 910, the encoding module 920, the first generation module 930, the encryption module 940 and the second generation module 950 or of the acquisition module 1010, the query module 1020, the obtaining module 1030, the decryption module 1040, the decoding module 1050 and the comparison module 1060 may be combined into one module/sub-module/unit for implementation, or any one of the modules/sub-modules/units may be divided into a plurality of modules/sub-modules/units. Alternatively, at least part of the functions of one or more of these modules/sub-modules/units may be combined with at least part of the functions of other modules/sub-modules/units and implemented in one module/sub-module/unit. According to embodiments of the present disclosure, at least one of the classification module 910, the encoding module 920, the first generation module 930, the encryption module 940 and the second generation module 950 or of the acquisition module 1010, the query module 1020, the obtaining module 1030, the decryption module 1040, the decoding module 1050 and the comparison module 1060 may be implemented at least partially as a hardware circuit, such as a field programmable gate array (FPGA), a programmable logic array (PLA), a system on a chip, a system on a substrate, a system on a package, an application specific integrated circuit (ASIC), or may be implemented by hardware or firmware in any other reasonable manner of integrating or encapsulating the circuit, or may be implemented by any one of the three implementation modes of software, hardware and firmware or an appropriate combination thereof. Alternatively, at least one of the classification module 910, the encoding module 920, the first generation module 930, the encryption module 940 and the second generation module 950 or of the acquisition module 1010, the query module 1020, the obtaining module 1030, the decryption module 1040, the decoding module 1050 and the comparison module 1060 may be at least partially implemented as a computer program module that may perform corresponding functions when executed.

It should be noted that a part for the apparatus of detecting the object and the apparatus of training the deep learning model in embodiments of the present disclosure corresponds to a part for the method of detecting the object and the method of training the deep learning model in embodiments of the present disclosure. For the descriptions of the apparatus of detecting the object and the apparatus of training the deep learning model, reference may be made to the method of detecting the object and the method of training the deep learning model, and details will not be repeated here.

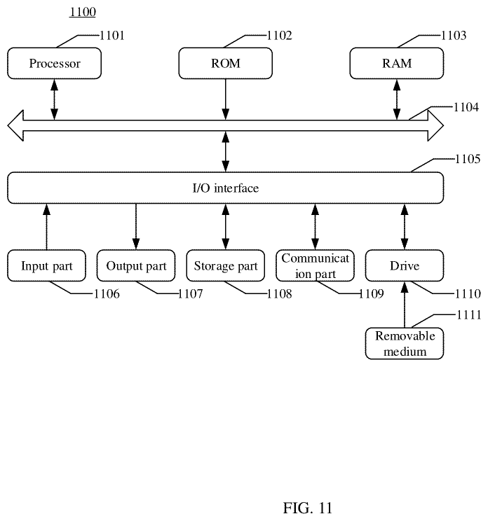

FIG. 11 schematically shows a block diagram of an electronic device suitable for implementing the method of detecting the object and the method of training the deep learning model according to embodiments of the present disclosure. The electronic device shown in FIG. 11 is just an example, and should not bring any limitation to functions and scopes of use of embodiments of the present disclosure.

As shown in FIG. 11, an electronic device 1100 according to embodiments of the present disclosure includes a processor 1101, which may execute various appropriate actions and processing according to the program stored in a read only memory (ROM) 1102 or the program loaded into a random access memory (RAM) 1103 from a storage part 1108. The processor 1101 may, for example, include a general-purpose microprocessor (for example, CPU), an instruction set processor and/or a related chipset and/or a special-purpose microprocessor (for example, an application specific integrated circuit (ASIC)), and the like. The processor 1101 may further include an on-board memory for caching purposes. The processor 1101 may include a single processing unit or multiple processing units for executing different actions of the method flow according to embodiments of the present disclosure.

Various programs and data required for the operation of the device 1100 are stored in the RAM 1103. The processor 1101, the ROM 1102 and the RAM 1103 are connected to each other through a bus 1104. The processor 1101 executes various operations of the method flow according to embodiments of the present disclosure by executing the programs in the ROM 1102 and/or the RAM 1103. It should be noted that the program may also be stored in one or more memories other than the ROM 1102 and the RAM 1103. The processor 1101 may also execute various operations of the method flow according to embodiments of the present disclosure by executing the programs stored in the one or more memories.

According to embodiments of the present disclosure, the electronic device 1100 may further include an input/output (I/O) interface 1105 which is also connected to the bus 1104. The device 1100 may further include one or more of the following components connected to the I/O interface 1105: an input part 1106 including a keyboard, a mouse, etc.; an output part 1107 including a cathode ray tube (CRT), a liquid crystal display (LCD), etc. and a speaker, etc.; a storage part 1108 including a hard disk, etc.; and a communication part 1109 including a network interface card such as a LAN card, a modem, and the like. The communication part 1109 performs communication processing via a network such as the Internet. A drive 1110 is also connected to the I/O interface 1105 as required. A removable medium 1111, such as a magnetic disk, an optical disk, a magneto-optical disk, a semiconductor memory, and the like, is installed on the drive 1110 as required, so that the computer program read therefrom is installed into the storage part 1108 as needed.

The method flow according to embodiments of the present disclosure may be implemented as a computer software program. For example, embodiments of the present disclosure include a computer program product including a computer program carried on a computer-readable storage medium. The computer program includes a program code for execution of the method shown in the flowchart. In such embodiments, the computer program may be downloaded and installed from the network through the communication part 1109, and/or installed from the removable medium 1111. When the computer program is executed by the processor 1101, the above-mentioned functions defined in the system of embodiments of the present disclosure are performed. According to embodiments of the present disclosure, the above-described systems, apparatuses, devices, modules, units, etc. may be implemented by computer program modules.

The present disclosure further provides a computer-readable storage medium, which may be included in the apparatus/device/system described in the above embodiments; or exist alone without being assembled into the apparatus/device/system. The above-mentioned computer-readable storage medium carries one or more programs that when executed, perform the methods according to embodiments of the present disclosure.

According to embodiments of the present disclosure, the computer-readable storage medium may be a non-transitory computer-readable storage medium, for example, may include but not limited to: a portable computer disk, a hard disk, a random access memory (RAM), a read-only memory (ROM), an erasable programmable read-only memory (EPROM or flash memory), a portable compact disk read-only memory (CD-ROM), an optical storage device, a magnetic storage device, or any suitable combination of the above. In the present disclosure, the computer-readable storage medium may be any tangible medium that contains or stores programs that may be used by or in combination with an instruction execution system, apparatus or device.

For example, according to embodiments of the present disclosure, the computer-readable storage medium may include the above-mentioned ROM 1102 and/or RAM 1103 and/or one or more memories other than the ROM 1102 and RAM 1103.

Embodiments of the present disclosure further include a computer program product, which contains a computer program. The computer program contains program code for performing the method provided by the embodiments of the present disclosure. When the computer program product runs on an electronic device, the program code causes the electronic device to implement the method of detecting the object and the method of training the deep learning model provided in embodiments of the present disclosure.

When the computer program is executed by the processor 1101, the above-mentioned functions defined in the system/apparatus of the embodiments of the present disclosure are performed. According to the embodiments of the present disclosure, the above-described systems, apparatuses, modules, units, etc. may be implemented by computer program modules.

In an embodiment, the computer program may rely on a tangible storage medium such as an optical storage device and a magnetic storage device. In another embodiment, the computer program may also be transmitted and distributed in the form of signals on a network medium, downloaded and installed through the communication part 1109, and/or installed from the removable medium 1111. The program code contained in the computer program may be transmitted by any suitable medium, including but not limited to a wireless one, a wired one, or any suitable combination of the above.

According to the embodiments of the present disclosure, the program code for executing the computer programs provided by the embodiments of the present disclosure may be written in any combination of one or more programming languages. In particular, these computing programs may be implemented using high-level procedures and/or object-oriented programming languages, and/or assembly/machine languages. Programming languages include, but are not limited to, Java, C++, Python, “C” language or similar programming languages. The program code may be completely executed on the user computing device, partially executed on the user device, partially executed on the remote computing device, or completely executed on the remote computing device or server. In a case of involving a remote computing device, the remote computing device may be connected to a user computing device through any kind of network, including a local area network (LAN) or a wide area networks (WAN), or may be connected to an external computing device (e.g., through the Internet using an Internet service provider).

The flowcharts and block diagrams in the accompanying drawings illustrate the possible architecture, functions, and operations of the system, method, and computer program product according to various embodiments of the present disclosure. In this regard, each block in the flowcharts or block diagrams may represent a part of a module, a program segment, or a code, which part includes one or more executable instructions for implementing the specified logical function. It should be further noted that, in some alternative implementations, the functions noted in the blocks may also occur in a different order from that noted in the accompanying drawings. For example, two blocks shown in succession may actually be executed substantially in parallel, or they may sometimes be executed in a reverse order, depending on the functions involved. It should be further noted that each block in the block diagrams or flowcharts, and the combination of blocks in the block diagrams or flowcharts, may be implemented by a dedicated hardware-based system that performs the specified functions or operations, or may be implemented by a combination of dedicated hardware and computer instructions. Those skilled in the art may understand that the various embodiments of the present disclosure and/or the features described in the claims may be combined in various ways, even if such combinations are not explicitly described in the present disclosure. In particular, without departing from the spirit and teachings of the present disclosure, the various embodiments of the present disclosure and/or the features described in the claims may be combined in various ways. All these combinations fall within the scope of the present disclosure.

Embodiments of the present disclosure have been described above. However, these embodiments are for illustrative purposes only, and are not intended to limit the scope of the present disclosure. Although the various embodiments have been described separately above, this does not mean that measures in the respective embodiments may not be used in combination advantageously. The scope of the present disclosure is defined by the appended claims and their equivalents. Those skilled in the art may make various substitutions and modifications without departing from the scope of the present disclosure, and these substitutions and modifications should all fall within the scope of the present disclosure.

1. A method of generating an anti-forgery information, comprising:
performing a classification on a product information according to a field type of the product information, so as to obtain a numeric field and a text field;
encoding the text field to obtain an encoded field;
generating a field to be processed, according to a random number, the numeric field and the encoded field;
encrypting the field to be processed to obtain an initial anti-forgery field; and
generating a target anti-forgery information according to the initial anti-forgery field and the numeric field.

2. The method according to claim 1, wherein the generating a field to be processed according to a random number, the numeric field and the encoded field comprises:
obtaining a field length of the product information according to the numeric field and the encoded field;
obtaining a target random field from the random number according to the field length and a field length threshold; and
generating the field to be processed according to the target random field, the numeric field and the encoded field.

3. The method according to claim 2, wherein the obtaining a field length of the product information according to the numeric field and the encoded field comprises:
determining a length of the numeric field according to the numeric field;
determining a length of the encoded field according to the encoded field; and
obtaining the field length of the product information according to the length of the numeric field and the length of the encoded field.

4. The method according to claim 2, wherein the obtaining a target random field from the random number according to the field length and a field length threshold comprises:
determining a target number of bytes according to the field length and the field length threshold; and
obtaining, based on a field query strategy, the target random field from the random number according to the target number of bytes.

5. The method according to claim 4, wherein the obtaining, based on a field query strategy, the target random field from the random number according to the target number of bytes comprises:
determining a query start position and a query direction based on the field query strategy;
determining a query end position according to the query start position, the query direction and the target number of bytes; and
retrieving the target random field from the random number according to the query start position and the query end position.

6. The method according to claim 2, wherein the generating the field to be processed according to the target random field, the numeric field and the encoded field comprises:
generating an information code according to the numeric field and the encoded field;
determining an embedding position information of the target random field; and
embedding the target random field into the information code according to the embedding position information, so as to generate the field to be processed.

7. The method according to claim 1, wherein the encrypting the field to be processed to obtain an initial anti-forgery field comprises:
determining a target key according to the random number by querying an anti-forgery information database; and
encrypting the field to be processed by using the target key, so as to obtain the initial anti-forgery field.

8. The method according to claim 7, wherein the encrypting the field to be processed by using the target key so as to obtain the initial anti-forgery field comprises:
determining a target encryption algorithm according to a type of the target key; and
encrypting the field to be processed by using the target key based on the target encryption algorithm, so as to obtain the initial anti-forgery field.

9. The method according to claim 1, wherein the generating a target anti-forgery information according to the initial anti-forgery field and the numeric field comprises:
determining an embedding position information of the numeric field; and
embedding the numeric field into the initial anti-forgery field according to the embedding position information, so as to generate the target anti-forgery information.

10. The method according to claim 9, wherein the embedding the numeric field into the initial anti-forgery field according to the embedding position information so as to generate the target anti-forgery information comprises:
embedding the numeric field into the initial anti-forgery field according to the embedding position information, so as to obtain a target anti-forgery field;
determining a display type of the target anti-forgery field according to the product information; and
processing the target anti-forgery field based on the display type, so as to obtain the target anti-forgery information.

11. A method of verifying a product, comprising:
acquiring, in response to a verification request for a product information being received, the product information and an anti-forgery information corresponding to the product information, wherein the anti-forgery information is generated using the method of claim 1;
obtaining, by querying an anti-forgery information database, an embedding position information of a numeric field according to the product information;
obtaining, from the anti-forgery information, the numeric field and an initial anti-forgery field according to the embedding position information of the numeric field;
decrypting the initial anti-forgery field to obtain a random number, the numeric field and an encoded field;
decoding the encoded field to obtain a text field; and
obtaining a verification result of the product information by comparing the product information with the numeric field and the text field.

12. The method according to claim 11, wherein the decrypting the initial anti-forgery field to obtain a random number, the numeric field and an encoded field comprises:
obtaining, by querying the anti-forgery information database, the random number and a target key according to the product information; and
decrypting the initial anti-forgery field by using the target key, so as to obtain the random number, the numeric field and the encoded field.

13. The method according to claim 12, wherein the decrypting the initial anti-forgery field by using the target key, so as to obtain the random number, the numeric field and the encoded field comprises:
determining a target encryption algorithm according to a type of the target key; and
decrypting the initial anti-forgery field by using the target key based on the target encryption algorithm, so as to obtain the random number, the numeric field and the encoded field.

14. (canceled)

15. (canceled)

16. An electronic device, comprising:
a processor; and
a memory for storing a program, wherein the program is configured to, when executed by the processor, cause the processor to implement the method of claim 1.

17. A non-transitory computer-readable storage medium having executable instructions therein, wherein the instructions are configured to, when executed by a processor, cause the processor to implement the method of claim 1.

18. (canceled)

19. The electronic device according to claim 16, wherein the processor is further configured to:
obtain a field length of the product information according to the numeric field and the encoded field;
obtain a target random field from the random number according to the field length and a field length threshold; and
generate the field to be processed according to the target random field, the numeric field and the encoded field.

20. The electronic device according to claim 19, wherein the processor is further configured to:
determine a length of the numeric field according to the numeric field;
determine a length of the encoded field according to the encoded field; and
obtain the field length of the product information according to the length of the numeric field and the length of the encoded field.

21. The electronic device according to claim 19, wherein the processor is further configured to:
determine a target number of bytes according to the field length and the field length threshold; and
obtain, based on a field query strategy, the target random field from the random number according to the target number of bytes.

22. An electronic device, comprising:
a processor; and
a memory for storing a program, wherein the program is configured to, when executed by the processor, cause the processor to implement the method of claim 11.

23. A non-transitory computer-readable storage medium having executable instructions therein, wherein the instructions are configured to, when executed by a processor, cause the processor to implement the method of claim 11.
